(19) United States
(12) Patent Application Publication
(10) Pub. No.: US 2010/0027388 A1
(43) Pub. Date: Feb. 4, 2010

(54) INFORMATION REPRODUCING APPARATUS AND METHOD, AND COMPUTER PROGRAM

(75) Inventors: Hitoshi Kudo, Saitama (JP); Shogo Suzuki, Saitama (JP); Katsunobu Kobayashi, Tokyo (JP)

Correspondence Address: YOUNG & THOMPSON, 209 Madison Street, Suite 500, Alexandria, VA, 22314, US

(73) Assignee: PIONEER CORPORATION, TOKOROZAWA WORKS., Tokyo (JP)

(21) Appl. No.: 12/529,067

(22) PCT Filed: Mar. 1, 2007
(86) PCT No.: PCT/JP2007/053958

§ 371 Date: Oct. 16, 2009

(51) Int. Cl. G11B 27/02

(52) U.S. Cl. 369/47.13; G9B/27.004

(57) ABSTRACT

An information reproducing apparatus (1) is provided with: a reading device (10) for reading contents data; an operating device (41) constructed to rotate depending on an operation of a user; a reproducing device (15) for reproducing the contents data, while determining reproduction speed and reproduction direction of the contents data on the basis of the operating signal which shows a rotating operation of the user performed on the operating device; and an adjusting device (22) for adjusting reproducing intensity of a plurality of data parts distributed in the contents data periodically or discretely during the reproduction of the contents data.

### BACKGROUND OF THE INVENTION

1. Field of the Invention

The present invention relates to an information reproducing apparatus and method, which reproduces sound information and video information recorded on an information recording medium. The present invention further relates to a computer program used in such an information reproducing apparatus.

2. Description of the Related Art

Recently, a recording medium such as CD and DVD which is able to record and reproduce data by using digital signal become common. According to this, an information reproducing apparatus operating specific reproducing process arises from a digital signal has been developed. For example, in case of CDs and DVDs, a series of video scenes and a piece of music (it means contents data) is recorded thereon relating to each other. For example, in case of a movie, each video scene with predetermined reproduction time is recorded as a plurality of data group, in order to be able to be reproduced according to a series of a reproduction sequence specified by PGC (Program Group Chain) and a playlist. For example, in case of music, each piece of music with predetermined reproduction time is recorded as a plurality of data group classified according to its track number. Because of this, the information reproducing apparatus can carry out a cue reproduction which reproduces each of video scenes and music by searching a heading address of them, a random reproduction which reproduces each of video scenes and music while changing their reproduction order arbitrarily and the like.

Moreover, an information reproducing apparatus which possesses a jog dial such as DJ (Disc Jockey) equipment can carry out a particular kind of reproduction such as a reverse reproduction, a scratch reproduction and the like. The reverse reproduction is a reproduction method which is opposite from forward reproduction which is usually carried out. In the reverse reproduction, contents data, which should be reproduced in the forward direction as time goes on, are reproduced in the backward direction. This is achieved by rotating the jog dial in reverse direction (it means rotating in a counter-clockwise direction). Moreover, in the scratch reproduction, by shuttling the jog dial in a clockwise direction and in a counter clockwise direction, the reproduction of the contents data in the forward direction and the reverse direction is carried out by turns. As a result, a sound effect such as a scratch sound, which is different from a sound which is usually output, is output (see patent document 1). Regarding such a scratch sound, a technique to mute a part of a sound reproduced by one player by operating a cross fader on the mixer, which mixes sounds of the two players (for example, a continuous muting scratch such a transformer scratch, a crab scratch and a flare scratch) is common.

Moreover, a structure (so-called an mixer with an effecting function) which edits and processes the contents data reproduced as described above by performing muting processing is disclosed in patent document 2.

Patent document 1: Japanese Patent Application Laid Open NO. 2002-34026

Patent document 2: Japanese Patent Application Laid Open NO. 2006-24983

### SUMMARY OF THE INVENTION

However, because a proficient skill is required in order to perform so-called the scratch reproduction, it cannot be performed easily. Moreover, because the scratch reproduction or the like is performed by manual operation of jog dial with hands of a user, such a limit that the shuttling operation of at most several Hz can be performed exists even if the user has the proficient skill. However, there lies such a problem that there is not always satisfaction in existing equipment, because more advanced reproduction technique might be desired depending on preference of an audience.

Problems the present invention tries to solve include a problem described above as an example. It is therefore an object of the present invention to provide an information reproducing apparatus and method allowing more advanced reproduction technique to be performed easily, and a computer program which allows a computer to function as such an information reproducing apparatus.

The above objects can be achieved by an information reproducing apparatus of the present invention provided with: a reading device for reading contents data; an operating device constructed to rotate depending on an operation of a user; a reproducing device for reproducing the contents data, while determining reproduction speed and reproduction direction of the contents data on the basis of the operating signal which shows a rotating operation of the user performed on the operating device; and an adjusting device for adjusting reproducing intensity of a plurality of data parts distributed in the contents data periodically or discretely during the reproduction of the contents data.

The above objects can be also achieved by an information reproducing method of the present invention of an information reproducing apparatus provided with an operating device constructed to rotate depending on an operation of a user, the information reproducing method provided with: a reading process of reading contents data; a reproducing process for reproducing the contents data while determining reproduction speed and reproduction direction of the contents data on the basis of the operating signal which shows a rotating operation of the user performed on the operating device; and an adjusting process for adjusting reproducing intensity of a plurality of data parts distributed in the contents data periodically or discretely during the reproduction of the contents data.

The above objects can be also achieved by a computer program of the present invention for controlling the reproduction to control a computer provided in an information reproducing apparatus provided with a reading device for reading contents data; an operating device constructed to rotate depending on an operation of a user; a reproducing device for reproducing the contents data, while determining reproduction speed and reproduction direction of the contents data on the basis of the basis of the operating signal which shows a rotating operation of the user performed on the operating device; and an adjusting device for adjusting reproducing intensity of a plurality of data parts distributed in the contents data periodically or discretely during the reproduction of the contents data, the computer program making the computer function at least as one portion of the reading device, the reproducing device and the adjusting device.

A function and other benefit of the present invention will be made clear by the embodiment described below.

### BRIEF DESCRIPTION OF THE DRAWINGS

FIG. 1 is a block diagram schematically showing the basic structure of an optical disc reproducing apparatus of the example of the present invention.

FIG. 2 is a block diagram schematically showing the structure especially of a signal processor of the optical disc reproducing apparatus of the example of the present invention.

FIG. 3 is a flowchart schematically showing a flow of the operation of the optical disc reproducing apparatus of the example of the present invention.

FIG. 4 is a wave profile schematically showing the pre-processed contents data and the processed contents data by a scratch emulation processor.

FIG. 5 is a block diagram schematically showing the basic structure of the optical disc reproducing apparatus of the alternative example of the present invention.

FIG. 6 is a block diagram schematically showing the basic structure of the optical disc reproducing apparatus of the other example of the present invention.

### DESCRIPTION OF THE REFERENCE SIGNS

1 optical disc reproducing apparatus

10 optical pickup

11 RF amplifier

15 signal processor

20 system controller

22 scratch emulation processor

40 operation unit

41 jog dial

42 encoder

43 touch sensor

44 scratch emulation mode-in button

### DETAILED DESCRIPTION OF THE PREFERRED EMBODIMENTS

Hereinafter, an embodiment of the information reproducing apparatus, the information reproducing method and the computer program of the present invention will be explained as the best mode for carrying out the invention.

### Embodiments of Information Reproducing Apparatus

An embodiment of the information reproducing apparatus of the present invention is provided with: a reading device for reading contents data; an operating device constructed to rotate depending on an operation of a user; a reproducing device for reproducing the contents data, while determining reproduction speed and reproduction direction of the contents data on the basis of the operating signal which shows a rotating operation of the user performed on the operating device; and an adjusting device for adjusting reproducing intensity of a plurality of data parts distributed in the contents data periodically or discretely during the reproduction of the contents data.

According to the embodiment of the information reproducing apparatus of the present invention, contents data including video and sound recorded on a recording medium such as CD and DVD is read by the operation of the reading device. Then, the user can operate the operating device, for example, in order to perform special reproduction process to the contents data. The operating device is constructed to rotate depending on the operation of the user. A specific example of the operating device is a jog dial used for DJ equipment. A term “DJ” relating to the present invention means the one which reproduces the contents data in a broad sense including not only music but also video, by using special technique

The content of operation performed on the operating device (especially, rotating operation) is detected as an operating signal by the detecting device. Then, by the operation of the reproducing device, the contents data is reproduced on the basis of the operating signal.

In this embodiment, especially, during the reproduction of the contents data by the reproducing device,

the reproducing intensity of a data part corresponding to a part of data (in other words, plurality of the data parts distributed in the contents data periodically or discretely) in the contents data (for example, sound volume is the contents data is a sound, or brightness if the contents data is video) is adjusted by the operation of the adjusting device. For example, the reproducing intensity is adjusted so that the adjusted reproducing intensity become stronger than the pre-adjusted reproducing intensity or the adjusted reproducing intensity become weaker than the preadjusted reproducing intensity. Furthermore, the reproducing intensity is adjusted so that the adjusted reproducing intensity become “0”.

As described above, according to this embodiment, the contents data is reproduced so that the reproducing intensity is slightly and continuously changes, by the operation of the adjusting device. Such reproduction of the contents data is for example, a transformer scratch, a crab scratch and a flare scratch, and hereinafter is described as a “continuous varying reproducing intensity scratch”. One example of a technique to adjust the reproducing intensity to “0” belonging to the continuous varying reproducing intensity scratch is a continuous mute scratch. By this, without the operation of the user for the continuous varying reproducing intensity scratch, the continuous varying reproducing intensity scratch where the reproducing intensity changes slightly can be performed automatically. In other words, the continuous varying reproducing intensity scratch which had to be performed by the user operating in detail a cross fader of the mixer connected with the information reproducing apparatus externally, in case of the information reproducing apparatus which is not provide with the adjusting device, can be performed relatively easily. Therefore the burden of the operation necessary to perform the continuous varying reproducing intensity scratch on the user can be reduced. Furthermore, it is possible to receive the effects that the continuous varying reproducing intensity scratch can be stably performed every time in the same mode as far as the same adjustment is performed.

Furthermore, according to the mode of the adjustment of the reproducing intensity, the continuous varying reproducing intensity scratch can be achieved in the mode which is difficult or impossible to be achieved by the operation of the user performed on the operating device. Especially, the continuous varying reproducing intensity scratch can be achieved in the mode which has not been achieved before, by adjusting the reproducing intensity in a mode which allows the continuous varying reproducing intensity scratch to be achieved in the more special, more advanced or more complex mode. By this, a more advanced reproduction technique can be achieved relatively easily compared with the information reproducing apparatus where the adjustment of the reproducing intensity is not performed.

In one aspect of the embodiment of the information reproducing apparatus of the present invention, it is provided with: a configuring device for configuring whether or not to adjust the reproducing intensity; and wherein the adjusting device the reproducing intensity, if the configuring device configures to adjust the reproducing intensity.

According to this aspect, depending on the result of configuration of the configuring devices whether or not to adjust the reproducing intensity is determined. The configuring device may configure whether or not to adjust the reproducing intensity, based on the operation of the user performed on the prescribed operation button. By this, for example the reproducing intensity can be adjusted selectively only if the user wants. Therefore, during the reproduction of the contents data based on the operating signal (in other words, the reproduction of the contents data in the usual mode), the adjustment of the reproducing intensity (in other words, the reproduction of the contents data by a more advanced mode, specifically the continuous varying reproducing intensity scratch) can be performed. As a result, the contents data can be reproduced in more various modes.

In another aspect of the embodiment of the information reproducing apparatus of the present invention, the adjusting device adjusts the reproducing intensity while the operating device is operated by the user.

In this aspect, the reproducing intensity is adjusted while the operating device is operated. On the other side, the reproducing intensity is not adjusted while the operating device is not operated. In other words, it is determined whether or not to adjust the reproducing intensity according to whether or not the user is operating the operating device. Therefore, the user need not; perform an independent operation for starting or stopping the adjustment of the reproducing intensity described above As a result it is possible to improve the operability of the user.

In another aspect of the embodiment of the information reproducing apparatus of the present invention, the adjusting device adjusts the reproducing intensity to “0”.

According to this aspect, it is possible that the continuous muting scratch is performed properly.

In an aspect of the embodiment of the information reproducing further provided with an adjusting amount changing device for changing an adjusting amount of the reproducing intensity.

By virtue of such construction, the adjusting amount of the reproducing intensity (specifically, an increasing amount and a decreasing amount of the reproducing intensity) can be changed in more various modes. Therefore, the continuous varying reproducing intensity scratch can be performed in more various modes.

In an aspect of the embodiment of the information reproducing provided with an adjusting amount changing device, the adjusting amount changing device changes the adjusting amount in response to at least one of an operation speed and an operation amount which relate to the rotating operation of the operating device.

By virtue of such construction, the adjusting amount of the reproducing intensity can be changed in more various modes. Therefore, the continuous varying reproducing intensity scratch can be performed in more various modes.

In an aspect of the embodiment of the information reproducing provided with an adjusting amount changing device, the adjusting amount changing device changes the adjusting amount; in response to an operation of the operating device other than rotating operation.

By virtue of such construction, the adjusting amount of the reproducing intensity can be changed by using the operating device, in addition to reproduction of the contents data. In other words, two different kinds of operations can be performed by operating the operating device.

In another aspect of the embodiment of the information reproducing apparatus of the present invention is further provided with an interval changing device for changing intervals between the plurality of the data parts.

According to this aspect, because the intervals between the plurality of the data parts distributed periodically or discretely (in other words, the mode of the distribution of the plurality of the data parts and the timing when the adjustment of the reproducing intensity is performed)

can be changed arbitrarily, the contents data can be reproduced in more various modes. In other words, the mode of the reproduction of the continuous varying reproducing intensity scratch can be changed relatively easily.

In an aspect of the embodiment of the information reproducing provided with the interval changing device, the interval changing device changes intervals between the plurality of the data parts in response to at least one of an operation speed and an operation amount which relate to the rotating operation of the operating device.

By virtue of such construction, because the intervals between the plurality of the data parts can be changed in more various mode, the contents data can be reproduced in more various modes.

In an aspect of the embodiment of the information reproducing provided with the interval changing device, the interval changing device changes the intervals between the plurality of the data parts in response to an operation of the operating device other than rotating operation.

By virtue of such construction, the intervals between the plurality of the data parts can be changed by using the operating device, in addition to reproduction of the contents data. In other words, two different kinds of operations can be performed by operating the operating device.

### Embodiment of Information Reproducing Method

An embodiment of the information reproducing method of the present invention is an information reproducing method of an information reproducing apparatus provided with: provided with an operating device constructed to rotate depending on an operation of a user, the information reproducing method provided with: a reading process of reading contents data; a reproducing process for reproducing the contents data, while determining reproduction speed and reproduction direction of the contents data on the basis of the operating signal which shows a rotating operation of the user performed on the operating device; and an adjusting process for adjusting reproducing intensity of a plurality of data parts distributed in the contents data periodically or discretely during the reproduction of the contents data.

According to the embodiment of the information reproducing method of the present invention it is possible to receive the same effects as those of the information reproducing apparatus of the present invention described above.

Incidentally, in response to the various aspects of the embodiment of the information reproducing apparatus of the present invention described above, the embodiment of the information reproducing method of the present invention can adopt various aspects.

### Embodiment of Computer Program

An embodiment of the computer program of the present invention is a computer program for controlling the reproduction to control a computer provided in the information reproducing apparatus provided with a reading device for reading contents data; an operating device constructed to rotate depending on an operation of a user; a reproducing device for reproducing the contents data, while determining reproduction speed and reproduction direction of the contents data on the basis of the basis of the operating signal which shows a rotating operation of the user performed on the operating device; and an adjusting device for adjusting reproducing intensity of a plurality of data parts distributed in the contents data periodically or discretely during the reproduction of the contents data, the computer program making the computer function at least as one portion of the reading device, the reproducing device and the adjusting device.

According to the embodiment of the computer program of the present invention, each embodiment of the aforementioned information reproducing apparatus of the present invention can be embodied relatively readily, by loading the computer program from a recording medium for storing the computer program, such as a ROM, a CD-ROM, a DVD-ROM, a hard disc or the like which stores aforementioned computer program, into the computer, or by downloading the computer program into the computer via a communication device.

Incidentally, in response to the various aspects of the embodiment of the information reproducing apparatus of the present invention described above, the embodiment of the computer program of the present invention can adopt various aspects.

An embodiment of the computer program product of the present invention is a computer program product for tangibly embodying a program of instructions executable by a computer provided in an information reproducing apparatus comprising a reading device for reading contents data; an operating device constructed to rotate depending on an operation of a user; a reproducing device for reproducing the contents data, while determining reproduction speed and reproduction direction of the contents data on the basis of the operating signal which shows a rotating operation of the user performed on the operating device; and an adjusting device for adjusting reproducing intensity of a plurality of data parts distributed in the contents data periodically or discretely during the reproduction of the contents data (briefly the embodiment of the information reproducing apparatus of the present invention described above (however including various aspects of it)), the computer program product making the computer function at least as one portion of the reading device, the reproducing device and the adjusting device.

According to the embodiment of the computer program product of the present invention, each embodiment of the aforementioned information reproducing apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disc or the like, into the computer, or by downloading the computer program product, which may be a carrier wave, into the computer via a communication device. More specifically, the computer program product may include computer readable codes to cause the computer (or may comprise computer readable instructions for causing the computer) to function as each embodiment of the aforementioned information reproducing apparatus of the present invention.

Incidentally, in response to the various aspects of the embodiment of the information reproducing apparatus of the present invention described above, the embodiment of the computer program product of the present invention can adopt various aspects.

The nature, utility, and further features of this invention will be more clearly apparent from the following detailed description.

As explained above, according to the embodiment of the information reproducing apparatus and method of the present invention, it is provided with the reading device, operating device, detecting device, generating device and reproducing device or reading process detecting process, generating process and reproducing process. According to the embodiment of the computer program of the present invention, it makes the computer function as the embodiment of the information reproducing apparatus of the present invention. Therefore, a more advanced reproduction technique can be achieved relatively easily.

### EXAMPLE

Hereinafter, example of the present invention will be explained with reference to the drawings. Incidentally, example described below is the example when the information reproducing apparatus of the present invention is applied to the optical disc reproducing apparatus that has various reproducing functions, for example, the reproduction speed control, the tempo control, and the rewinding reproduction, such as CD players, DVD players or the like. Moreover, the optical disc reproducing apparatus of this example described below is used as DJ equipment (including the VJ (Video Jockey) equipment) which is used when the music data or the video data is continuously reproduced by adding various special effects (effect), while changing the optical disc one after another, in the ballroom such as the club, the disco and the like.

### (1) Basic Structure

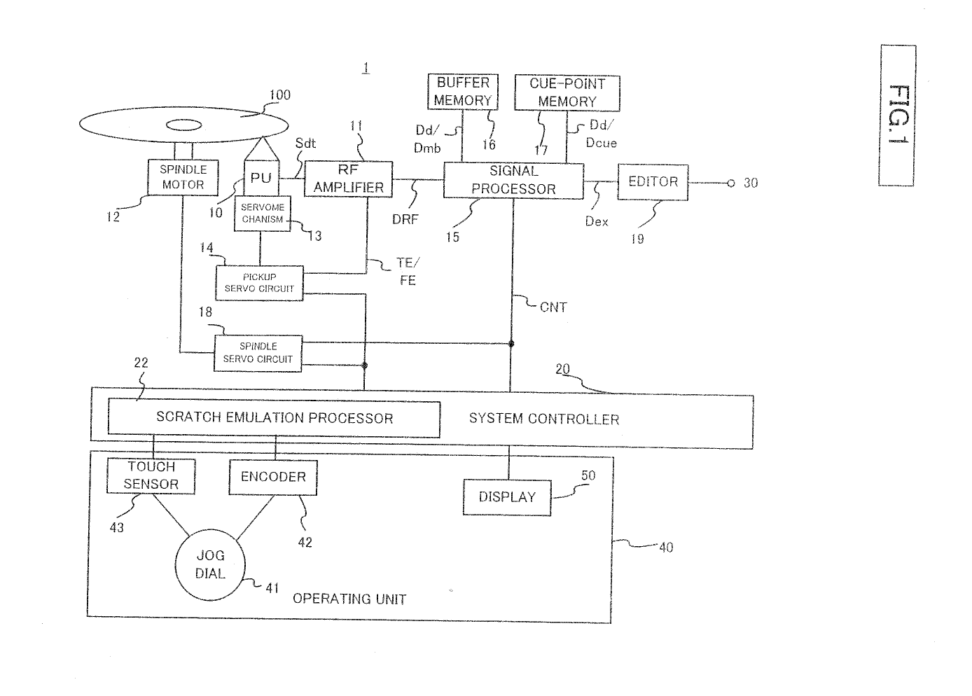

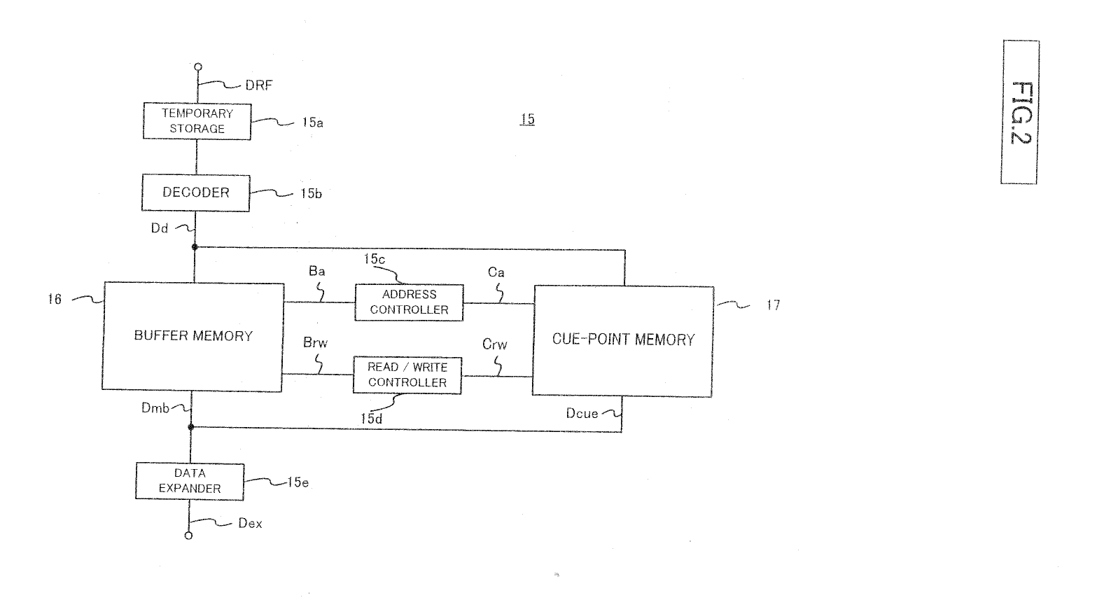

Firstly, with reference to FIG. 1 and FIG. 2, an explanation will be given on an optical disc reproducing apparatus of this example. FIG. 1 is a block diagram schematically showing the basic structure of an optical disc reproducing apparatus 1 of this example. FIG. 2 is a block diagram schematically showing the structure especially of a signal processor 15 of the optical disc reproducing apparatus of this example.

As shown in FIG. 1, an optical disc reproducing apparatus 1 of the example is provided with: an optical pickup (PU) 10; a RF (Radio frequency) amplifier 11; a spindle motor 12; a servomechanism 13; a pickup servo circuit 14; a signal processor 15; a buffer memory 16; a cue-point memory 17; a spindle servo circuit 18; an editing device 19; a system controller 20; an external output terminal 30; operating unit 40; a jog dial 41; an encoder 42; a touch sensor 43; and a display 50.

The optical pickup 10 composes one specific example of the reading device of the present invention and reads contents data containing movie and music, and control data which controls the reproduction of the contents data from the optical disc 100. The optical pickup 10 is composed from a semiconductor laser device, various lenses, actuators and so on. More specifically, the optical pickup 10 irradiates a laser beam LB with a prescribed power to the optical disc 100. Moreover, it is provided with the PD (Photo Detector) sensor of receiving optical for receiving reflected light of the laser beam. LB, and outputs the received reflected light as a readout signal Sdt to the RF amplifier 11.

The optical pickup 10 is constructed so that it can move in a radial direction of the optical disc 100 according to a tracking error signal TE, by the actuator, a slider and the like which is not illustrated and is driven by control of the servomechanism 13. In addition, the optical pickup 10 is constructed so that it can change the focus of the laser beam LB according to a focus error signal FE, by control of the servomechanism 13.

The RF amplifier 11 generates a RF signal DRF based on the readout signal Sdt which is output from the optical pickup 10, and outputs the generated RF signal DRF to the signal processor 15. Moreover, the RF amplifier 11 generates an error signal such as the focus error signal FE for controlling the focus of the laser beam LB when the optical pickup 10 irradiates the laser beam LB to the optical disc 100 and the tracking error signal TE for controlling the tracking of the laser beam LB when the optical pickup 10 irradiates the laser beam LB to the optical disc 100, based on the readout signal Sdt. The generated error signals (FE and TE) are output to the pickup servo circuit 14.

The spindle motor 12 is constructed so that it can rotate the optical disc 100 at a prescribed speed while receiving a spindle servo from the spindle servo circuit 18.

The servomechanism 13 moves the optical pickup 10 in the radial direction of the optical disc 100 based on a tracking controlling signal output by the pickup servo circuit 14. Moreover, the servomechanism 13 moves an object lens included in the optical pickup 10, in a direction of a light axis of the laser beam LB based on a focus servo controlling signal output by the pickup servo circuit 14.

The pickup servo circuit 14 generates the focus servo controlling signal and the tracking servo controlling signal which control the servomechanism 13, based on the error signals (such as the focus error signal FE and the tracking error signal TE) output from the RF amplifier 11. The generated focus servo controlling signal and the generated tracking servo controlling signal are output to the servomechanism 13. In other words, the pickup servo circuit 14 performs a feedback control on the servomechanism 13 in order to suppress the occurrence of the focus error and the tracking error, based on the error signals (such as the focus error signal FE and the tracking error signal TE) output from the RF amplifier 11.

The signal processor 15 composes one specific example of the reproducing device of the present invention and is formed with the digital signal processor (DSP) which has the calculation function. The signal processor 15 generates demodulated data by decoding the RF signal DRF in accordance with the standard of the CD and the DVD. In addition, the signal processor 15 splits and extracts the contents data for the contents reproduction and control data CNT for seamless reproduction included in the demodulated data. Specific examples of the control data CNT are, for example, TOC data recorded in the lead-in area of the optical disc 100; synchronous data recorded to be included in the stream signal; and sub-code data including the information of the passage of time when the contents data is reproduced. The generated control data CNT is output to the system controller 20, and used to control the reproduction of the contents data (especially, to decode the contents data to the contents data Dd which can be reproduced seamlessly).

With reference to FIG. 2, an explanation will be given on the more specific structure of the signal processor 15.

As shown in FIG. 2, the signal processor 15 is provided with: a temporary storage 15a; a decoder 15b which performs the decode process described above; an address controller 15c; read/write controller 15e; and a data expander 15e. Moreover, the buffer memory 16 and the cue-point memory 17 are connected with the signal processor 15.

The temporary storage 15a temporarily stores the RF signal DRF output from the RF amplifier 11 and is installed as a work area where the decoder 15b decodes the RF signal DRF to thereby generate the contents data Dd for the seamless reproduction.

The buffer memory 16 is formed with the ring memory which has a prescribed memory capacity. The buffer memory 16 stores the contents data Dd decoded by the decoder 15b and outputs the contents data Dd once stored as contents data Dmb, according to the control of the address controller 15c and the read/write controller 15d. Mainly, the buffer memory 16 stores the contents data Dd which should be reproduced during the forward reproduction, the reverse reproduction and the reciprocal reproduction (in other words, the scratch reproduction), and outputs as the contents data Dmb.

The cue-point memory 17 is formed with the semiconductor memory that has a prescribed memory capacity. The cue-point memory 17 stores the contents data Dd decoded by the decoder 15b and outputs the contents data Dd once stored as contents data Dcue, according to the control of the address controller 15c and the read/write controller 15d.

However, unlike the buffer memory 16, the cue-point memory 17 is constructed so that it stores a prescribed amount of the contents data Dd which is in front or in the rear of the cue-point for the cue reproduction, and outputs the stored contents data Dd as the contents data Dcue relating to the cue-point when the user specifies the cue reproduction.

The decoder 15b supplies the contents data Dd to the buffer memory 16 or the cue-point memory 17 and makes them store the content data Dd according to the instruction from the system controller 20, when the contents data Dd is generated as described above. In other words, during the forward reproduction, the reverse reproduction and the scratch reproduction, the decoder 15b makes the contents data Dd, which is obtained by reading the information from the optical disc 100 by the optical pickup 10, be stored on the buffer memory 16. Moreover, when the cue-point is configured by the user, the decoder 15b makes the contents data Dd, which is obtained by reading the information which is in front or in the rear of the cue-point by the optical pickup 10, be stored on the cue-point memory 17, the contents data Dd.

The address controller 15c generates address data Ba which specifies an address of the buffer memory 16 and address data Ca which specifies an address of the cue-point memory 17 according to the instruction from the system controller 20.

The read/write controller 15d controls the writing and the reading of the data in the buffer memory 16 and the writing and the reading of the data in the cue-point memory 17 by supplying read-write signals Brw and Crw to the buffer memory 16 and the cue-point memory 17 according the instruction from the system controller 20.

In other words, when the address controller 15c specifies the address of the buffer memory 16 and the read/write controller 15c performs the writing control, the contents data Dd is stored on the specified address. On the other hand, when the address controller 15c specifies the address of the buffer memory 16 and the read/write controller 15c performs the reading control, the contents data Dd stored on the specified address is output as the contents data Dmb.

Moreover, when the address controller 15c specifies the address of the cue-point memory 17 and the read/write controller 15c performs the writing control, the contents data Dd is stored on the specified address. On the other hand, when the address controller 15c specifies the address of the cue-point memory 17 and the read/write controller 15c performs the reading control, the contents data Dd stored on the specified address is output as the contents data Dcue relating to the cue-point.

In addition, access timing by the address controller 15c and the read/write controller 15d when the contents data is read from the buffer memory 16 or the cue-point memory 17 changes in response to the rotation speed of the jog dial 41. Moreover, the process speed described above changes according to the change of the access timing.

In other words, when instruction of the forward reproduction is given by the user or the like and then the jog dial 41 has stopped, the signal processor 15 reads the contents data Dmb or Dcue from the buffer memory 16 or the cue-point memory 17 at the access timing corresponding to a regular reproduction speed and processes the reproduction of the contents. Therefore, usual reproduction of the contents is performed at a regular processing speed.

On the other hand, if the rotating operation of the jog dial 41 is performed in a clockwise or a counter-clockwise direction, the signal processor 15 reads the contents data Dmb or Dcue from the buffer memory 16 or the cue-point memory 17 at the access timing corresponding to each rotation speed. Therefore, if the rotating operation of the jog dial 41 is performed in a clockwise or a counter-clockwise direction, the reproducing speed changes according to the change of the access timing. Thus, for example, if the jog dial 41 is operated while reproducing music or the like, sound of a reproduction speed different from a regular reproduction sound is reproduced.

Incidentally, the reproduction speed described above corresponds to a switching speed of the reading address when performing the memory access to the buffer memory 16 or the cue-point memory 17 and switching sequentially the reading address, while reading the contents data stored on the buffer memory 16 or the cue-point memory 17 and reproducing the contents based on the contents data.

Therefore, the switching speed of the reading address to the buffer memory 16 or the cue-point memory 17 changes if jog dial 41 is operated. Then, if the contents is reproduced based on the contents data read from the buffer memory 16 or the cue-point memory 17 according to the changes of the switching speed, for example, video or sound of a tempo different from a regular reproduction sound or the like is reproduced on the display, speaker or the like.

Incidentally, in the forward reproduction described above, the contents data recorded in the optical disc 100 is reproduced in the order recorded as well as music is reproduced by rotating an analog record such as LP in a forward direction. Therefore, in response to the rotating operation performed on the jog dial 41 in a clockwise direction, music is reproduced as usual sound. Moreover, while the jog dial 41 has been stopped, the forward reproduction is performed.

On the other hand, in the reverse reproduction described above, the contents data recorded in the optical disc 100 is reproduced in the reverse order recorded as well as music is reproduced by rotating an analog record in a reverse direction. In other words, because music is sequentially recorded (recorded in analog) in the analog record, when the analog record is rotated in the reverse direction, a sound effect different from original music is reproduced. However, when the jog dial 41 is operated to rotate to a counter-clockwise direction, the same sound effect as reproducing the analog record by rotating to the reverse direction is generated.

Because of such function same as reverse reproducing of the analog record, when, for example, the user rotates the jog dial 41 back and forth to a clockwise direction and a counter-clockwise direction rapidly, the sound effect called scratch sound (for example, sound effects like [Kyu Kyu] or [Gasha Gasha]) can be generated. In addition, a player called disc jockey can edit to generate rap music using the CD or the DVD by operating the jog dial 41 to generate the scratch sound described above or the like.

Incidentally, the address controller 15c and the read/write controller 15d prohibit simultaneous writing of the contents data Dd from the decoder 15b and simultaneous reading of the contents data Dmb and Dd, by controlling the buffer memory 16 and the cue-point memory 17 respectively and separately.

Moreover, because a so-called writing process for recording the contents data Dd to each of the buffer memory 16 and the cue-point memory 17 having a prescribed memory capacity and a so-called reading process for reading the contents data Dmb and Dcue from the buffer memory 16 and the cue-point memory 17 are performed independently, a process of reading the information from the optical disc 100 of the optical pickup 10 and a process of reproducing the audio in the signal processor 15 have no influence to each other.

The data expander 15e expands the contents data Dmb or Dcue and supplies the expanded contents data Dex to the editor 19 shown in FIG. 19, when the contents data Dmb or Dcue compressed by the data compression technology is read from the buffer memory 16 or the cue-point memory 17. Moreover, if the contents data Dmb or Dcue is not compressed, the contents data Dmb or Dcue is supplied to the editor 19 in status quo without the expansion of the data being performed.

In FIG. 1 again, the spindle servo circuit 18 detects the error of the synchronous data to the rotation speed of the spindle motor 12 instructed by the system controller 20, and performs a feedback control on the rotation of the spindle motor 12 in order to suppress the occurrence of the error.

The editor 19 generates an analog contents signal by performing digital-analog conversion on the contents data Dex supplied from the signal processor 15 with the digital-analog converter which is not shown in the figure, and outputs it to the external output terminal 30 with amplifying its electric power. The output analog contents signal is output to an external output equipment such as a display and a speaker through the external output terminal 30 and reproduced as video and sound corresponding to the contents data recorded in the optical disc 100.

Incidentally, the digital-analog converter described above converts the contents data Dex into the analog contents signal by synchronizing with a fixed sampling frequency which is decided according to a so-called sampling theorem. Therefore, when the switching speed of the reading address to the buffer memory 16 or the cue-point memory 17 changes by the operation of the jog dial 41 as described below, and then the number of the contents data Dex supplied to the digital-analog converter per unit time changes, the analog contents signal which allows reproduction of, for example, sound of a tempo different from a regular reproduction sound or the like is output from the digital-analog converter.

The system controller 20 is provided with a micro processing unit (MPU) having function of calculation and control. The system controller collectively controls the whole operation of the optical disc reproducing apparatus 1 by processing a predetermined system program.

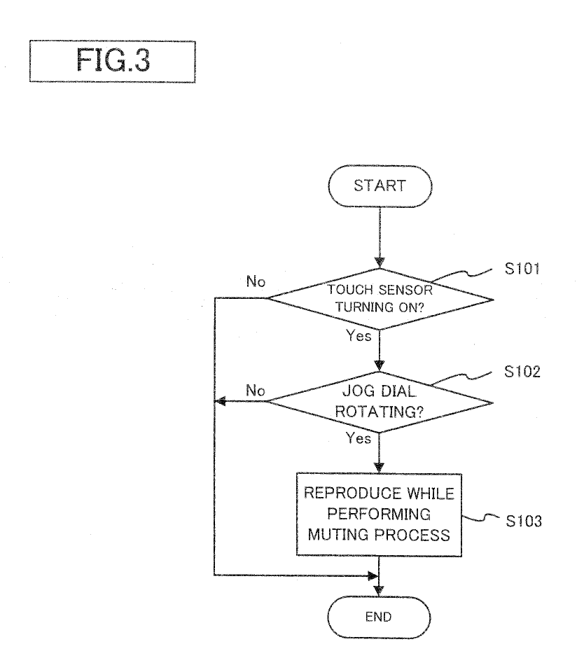

Moreover, the system controller 20 is provided with the scratch emulation processor 22. The scratch emulation processor 22 composes one specific example of the “adjusting device” of the present invention, and controls the signal processor 15 so that the muting process is performed at intervals of several times per second. By such process of the signal, the switching speed of the reading address to the buffer memory 16 or the cue-point memory 17 changes more complexly. As a result, the number of the contents data Dex supplied to the digital-analog converter per unit time changes more complexly. Such process will be explained later in more detail (refer to FIG. 3 and such).

The operation unit 40 is provided with the jog dial 41, the encoder 42, the touch sensor 43 and the display 50. The operation unit 40 is further provided with a plurality of operating buttons, for example, various operating buttons necessary for the reproducing operation such as a reproduction button, a pause button, and a stop button to direct the contents of the reproducing operation; a cue-point registration button to configure the cue-point described above; a cue-point specification button to specify the configured cue-point as the position for cue reproduction; and an edit button to be operated for adding various kind of sound effects.

The jog dial 41 composes one specific example of the “operating device” of the present invention, and is a disc-shaped operation key free to rotate to both directions (namely, a clockwise direction and a counter-clockwise direction). When the user operates the jog dial 41 while changing the rotation direction and the rotation speed properly, one of the forward reproduction or the reverse reproduction described above can be chosen according to the rotation direction, and the tone of the reproduced sound reproduced on the speaker and the headphone can be changed according to the rotation speed.

The encoder 42 composes one specific example of the “detecting device” of the present invention, and detects the rotation direction and the rotation speed (angular velocity) of the jog dial 41. More specifically, the encoder 42 has the rotary encoder circuit, and optically detects the rotation direction and the rotation speed of the jog dial 41. The detected rotation direction and rotation speed of the jog dial 41 are output to the system controller 20 as the operating signal. By this, the system controller 20 recognizes the operation amount of the jog dial 41 operated by the user, and performs the effect process corresponding to the operation amount. Moreover, the scratch emulation processor 22 recognizes the operation amount of jog dial 41 operated by the user, and adds the prescribed additional signal to the operating signal corresponding to the operation amount.

Incidentally, regarding the rotation direction, if a clockwise direction is decided as the forward direction and a counter-clockwise direction as the reverse direction, the operating signal shows the direction of the jog dial 41 with its sign, and shows the amplitude of the rotation speed (more specifically, the angular velocity) of the jog dial 41 with its value (it means absolute value).

The touch sensor 43 is a sensor to detect whether or not the user is operating the jog dial 41 (especially, whether or not the user is touching the jog dial 41 especially).

The display 50 displays various information according to the reproduction of the contents data. For example, the display 50 is provides with the display panels such as a liquid-crystal display and fluorescent tubes, and displays various information under the control of the system controller 20. For instance, various information corresponding to the reproduction of the contents data may be displayed in display 50. More specifically, a track number of the presently reproduced contents data, elapsed time of the presently reproduced contents data, and total track number of the contents data recorded in the optical disc 100 presently loaded in the optical disc reproducing apparatus may be displayed. In addition, the beat density of the contents data along the reproduction time axis may be displayed, and the amplitude of each bandwidth of the contents data presently reproduced may be displayed.

(2) Principle of the Operation

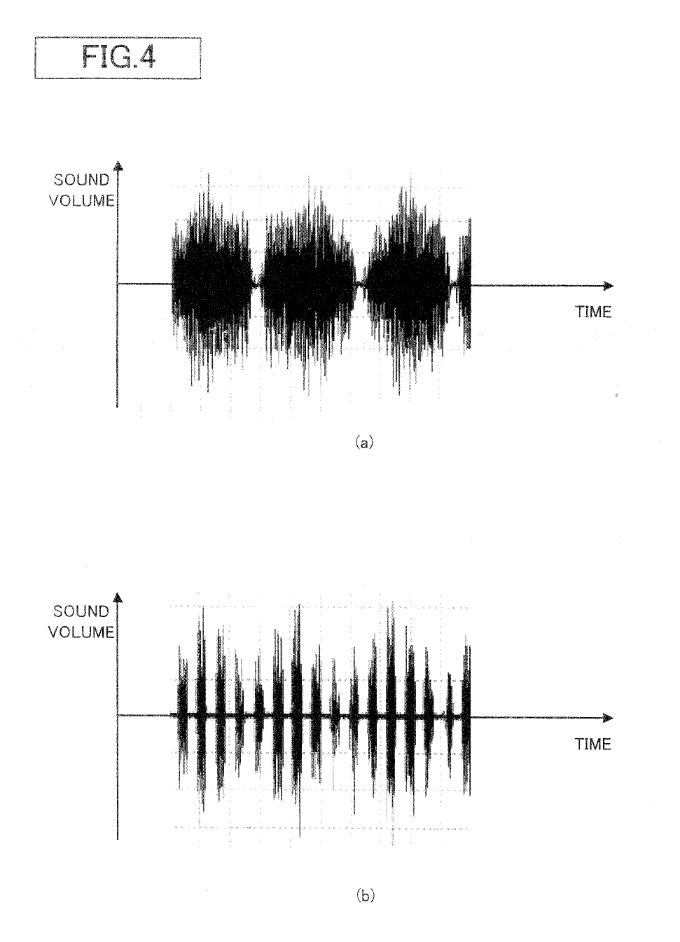

Next, with reference to FIG. 3 and FIG. 4, an explanation will be given on the principle of the operation of the optical disc reproducing apparatus 1. With reference to FIG. 3, an explanation will be given on the whole flow of the principle of the operation of the optical disc reproducing apparatus 1, and with reference other figures, more specific explanation will be given properly. FIG. 3 is a flowchart schematically showing a flow of the operation of the optical disc reproducing apparatus 1 relating to the example. Incidentally, in the following explanations, the explanation will be given focusing on the operation when the optical disc reproducing apparatus 1 performs the muting process at intervals of several times per second to the contents data.

As shown in FIG. 3, firstly, it is judged whether or not a turning on signal is detected by the touch sensor 43 (step S101). In other words, it is judged whether or not the user is touching the jog dial 41 or the user is operating the jog dial 41. If the user is touching the jog dial 41 or the user is operating the jog dial 41, the turning on signal is detected by the touch sensor 43.

As a result of the judgment, if the turning on signal has not been detected by the touch sensor 43 (step S101:No), the process of the scratch emulation is not processed and the operation is ended. However, it may be constructed to return to the step S101 again and continue to judges whether or not the turning on signal is detected in touch sensor 43.

On the other hand, if the turning on signal is detected in the touch sensor 43 (step S101:Yes), then it is judged whether or not the rotating operation is performed on the jog dial 41 (step S102).

As a result of the judgment in step S102, if it is judged that the rotating operation is not performed on the jog dial 41 (step S102:No), the operation is ended.

On the other hand, as a result of the judgment in step S102, if it is judged that the rotating operation is performed on the jog dial 41 (step S102:Yes), then the signal processor 15 is controlled so that the muting process to the contents data is performed at intervals of several times per second (step S103). As a result, the contents data is reproduced so that on/off of the muting is repeated at intervals of several times per second.

With reference to FIG. 4 an explanation will be given on a mode of the reproduction of the contents data. FIG. 4 is a wave profile schemzatically showing the pre-processed contents data and the processed contents data by the scratch emulation processor 22.

It is assumed that the contents data shown in FIG. 4 is obtained as a result of the operation of the user on the jog dial 41. Incidentally, the contents data shown in FIG. 4 is commonly found when the scratch reproduction is performed. In other words, it is the contents data commonly found as a result of the repeating operation of the jog dial 41 to each of a clockwise direction and a counter-clockwise direction.

Then, the scratch emulation processor 22 controls the signal processor 15 to perform the muting process to the contents data at intervals of several times per second. As a result the contents data actually reproduced is reproduced so that on/off of the muting is repeated at intervals of several times per second, as shown in FIG. 4(b). Specifically, the reproduction of the contents data achieved by repeating operation of the jog dial 41 to each of a clockwise direction and a counter-clockwise direction and slightly operating the cross fader of the mixer connected with the information reproducing apparatus 1 externally (in other words, a continuous muting scratch such as the transformer scratch, the crab scratch and the flare scratch, and hereinafter is described) can be achieved.

In other words, the reproduction of the contents data is achieved only by operating the jog dial 41 in a mode same as the a mode which is achieved by repeating the operation of the jog dial 41 to each of a clockwise direction and a counter-clockwise direction and slightly operating the cross fader of the mixer.

As explained above, according to the optical disc reproducing apparatus 1, the contents data is reproduced while the muting process is performed at intervals of several times per second by the scratch emulation processor 22, instead of merely based on the contents of the operation of the jog dial 41 by the user (in other words, the operating signal d). Therefore, the scratch reproduction (it means the continuous muting scratch) which is difficult or impossible to be achieved only by the manual operation of the jog dial 41 by the user can be achieved.

For example, even if the user who does not have the scratch skill (more specifically, cannot perform the continuous muting scratch) operates the jog dial 41, the continuous muting scratch can be performed relatively easily by the operation of the scratch emulation processor 22. On the other hand, if the user who has the scratch skill operates the jog dial 41, the continuous muting scratch in the special, complex, advanced and accurate mode which is impossible to be achieved by the manual operation of the jog dial 41 by the user can be achieved. Furthermore, it is obvious that the continuous muting scratch can be stably performed every time in the same mode (in other words, in the mode where the muting process is performed at same timing every times) as far as the interval between the muting processes is maintained constant by the scratch emulation processor 22.

Moreover, when the muting process is performed by the scratch emulation processor 22 as described above, the user need not operate the jog dial 41 in a complex mode. In other words, when the muting process is performed by the scratch emulation processor 22 as described above, the user only has to operate the jog dial 41 in a usual mode. Therefore, the burden of the operation of the user necessary to perform the continuous muting scratch can be reduced, as a result the continuous muting scratch can be achieved relatively easily. There is a large advantage that the burden of the operation of the user necessary to perform the continuous muting scratch not only in the mode which cannot achieved by the manual operation but also in the mode which can be achieved by the manual operation can be reduced. By this, the continuous muting scratch can be performed in the mode like the expert even if by the beginner player.

In addition, because the muting process by the scratch emulation processor 22 is performed while the jog dial 41 is pressed, the user can perform the continuous muting scratch by the operation with one hand. In other words, without operating the optical disc reproducing apparatus 1 and the effector or the mixer connected externally with both hands, the continuous muting scratch can be performed.

Incidentally, in the example described above, the muting process by the scratch emulation processor 22 is performed while it is judged that the rotating operation is performed on the jog dial 41. However, it may be constructed so that the muting process by the scratch emulation processor 22 is performed even if it is judged that the rotating operation is not performed on the jog dial 41. By virtue of such construction, even if the rotating operation is not performed by the user on the jog dial 41, if the user merely touches the jog dial 41 (more specifically, if the touch sensor 43 outputs the turning on signal), the continuous muting scratch described above can be performed relatively easily. It is a large advantage from a viewpoint of improvement of the operability of the user.

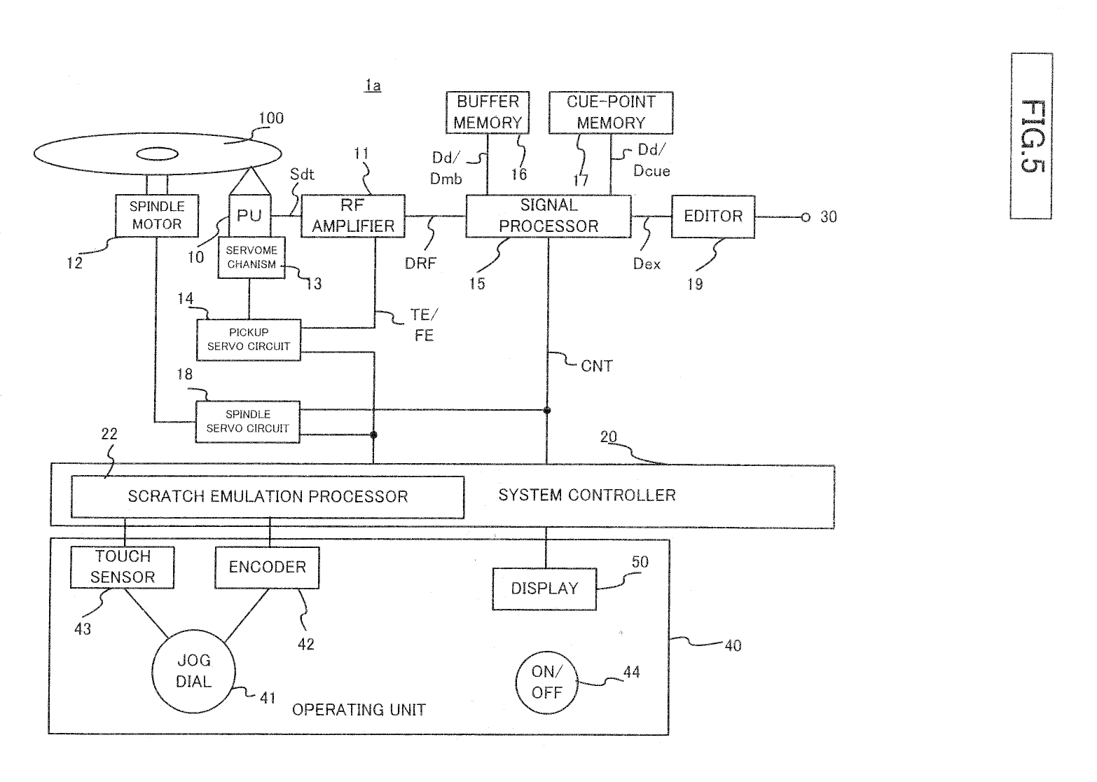

On the other hand, it may be constructed so that whether or not to perform the muting process by the scratch emulation processor 22 is determined directly according to an operation button other than the jog dial 41, in addition to or instead of the structure where the muting process by the scratch emulation processor 22 is performed by treating the pressing of the jog dial 41 or the rotating operation of the jog dial 41 as a trigger. In this case, as shown in the optical disc reproducing apparatus 1a of the other example of FIG. 5, a scratch emulation mode-in button 44 which composes one specific example of the “configuring device” of the present invention with the scratch emulation processor 22, is preferably provided on the operating unit 40.

The scratch emulation mode-in button 44 is an operation button which specifies whether or not to perform the muting process by the scratch emulation processor 22. If the user turns on the scratch emulation mode-in button 44, the muting process by the scratch emulation processor 22 is performed. On the other hand, if the user turns off the scratch emulation mode-in button 44, the muting process by the scratch emulation processor 22 is not performed, and the forward reproduction, the reverse reproduction, and the scratch reproduction are performed as usual.

As described above, it can be decided whether or not to perform the muting process by the scratch emulation processor 22 based on the instruction of the user using the scratch emulation mode-in button 44 which is the operation buttons other than the jog dial 41. Therefore, it is possible to perform the continuous muting scratch relatively easily by the muting process by the scratch emulation processor 22, and to perform the forward reproduction, the reverse reproduction, and the scratch reproduction as usual without the muting process by the scratch emulation processor 22 if the user wants. Therefore, the reproduction of the contents data can be performed in more various modes.

Moreover, because it can be switched whether or not to perform the muting process by the scratch emulation processor 22 by operating a single button, the operability of the user can be improved.

Incidentally, in the example described above, the explanation is given on the example where the muting process is performed on the contents data at intervals of several times per second. However, it may be constructed so that sound volume of the contents data is increased or decreased by a predetermined amount or a predetermined rate at intervals of several times per second, instead of the performing the muting process. In other words, it may be constructed so that the sound volume of the contents data is increased or decreased from the original sound volume by the predetermined amount or the predetermined rate at a certain timing, and the sound volume of the contents data becomes the original sound volume in the rest of the time.

Moreover, It may be constructed to adjust the interval between the muting processes (or the processes of increasing or decreasing the sound volume of the contents data) arbitrary. Moreover, it may be constructed to adjust an increasing amount or a decreasing amount (in other words, degree of increasing or decreasing) if the process of increasing or decreasing the sound volume of the contents data is performed.

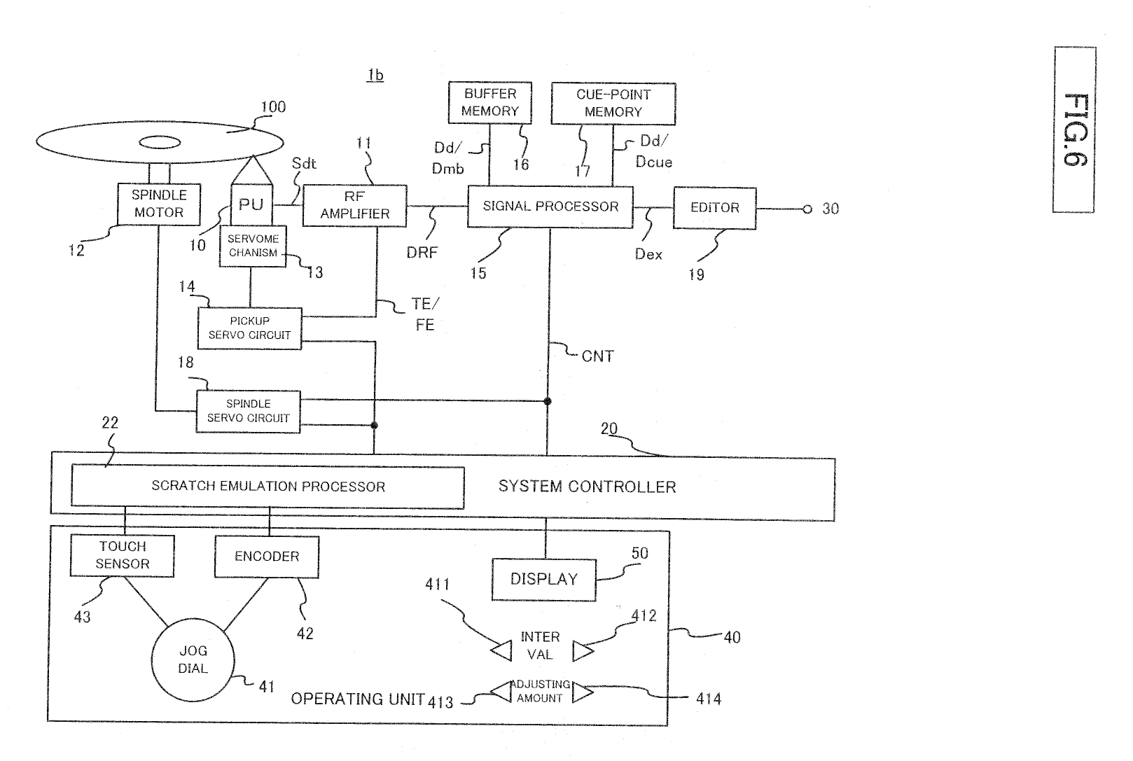

At that time, the changing operation of the interval between the muting processes (or the interval between the processes of increasing or decreasing the sound volume of the contents data) and the increasing amount or the decreasing amount (in other words, degree of increasing or decreasing) of the sound volume of the contents data may be performed based on the instruction of the user using an operation button provided on the operating unit 40. In this case, as shown in the optical disc reproducing apparatus 1b of the other example of FIG. 6, an interval decreasing button 411 for decreasing the interval between the muting processes (or the interval between the processes of increasing or decreasing the sound volume of the contents data); an interval increasing button 412 for increasing the interval between the muting processes (or the interval between the processes of increasing or decreasing the sound volume of the contents data); an adjusting amount decreasing button 413 for decreasing the increasing amount or the decreasing amount of the sound volume of the contents data; and an adjusting amount increasing button 414 for increasing the increasing amount or the decreasing amount of the sound volume of the contents data are preferably provided on the operating unit 40. If the instruction for changing interval between the muting processes (or the interval between the processes of increasing or decreasing the sound volume of the contents data) or the increasing amount or the decreasing amount of the sound volume of the contents data is input to the system controller 20 through these buttons 411 to 414 provided on the operating unit 40, the scratch emulation processor 22 changes the interval between the muting processes (or the interval between the processes of increasing or decreasing the sound volume of the contents data) or the increasing amount or the decreasing amount (in other words, degree of increasing or decreasing) of the sound volume of the contents data.

Incidentally, the scratch emulation processor 22 itself or the combination of the buttons 411 to 414 provided on the operating unit 40 and the scratch emulation processor 22 composes one specific example of the “adjusting amount changing device” or the “interval changing device” of the present invention.

Moreover, changing operation of the interval between the muting processes (or the interval between the processes of increasing or decreasing the sound volume of the contents data) may be performed according to the rotation speed and the rotation amount of the jog dial 41. For example, it may be constructed so that the faster the rotation speed of the jog dial 41 becomes, the shorter the interval between the muting processes (or the interval between the processes of increasing or decreasing the sound volume of the contents data) becomes.

Incidentally, in the example described above, the explanation is given on the example where the scratch emulation processor 22 adjusts the sound volume of the contents data. However, if the contents data contains video, the scratch emulation processor 22 may be constructed to adjust the brightness of the contents data. Even in the case, it is obvious that the various effects described above can be properly received.

Incidentally, in the examples described above, the explanation is given on the optical disc reproducing apparatus 1 which reproduces the contents data recorded in the optical disc 100. However, it is obvious that in the case of the reproducing apparatus which reproduces the contents data recorded in various recording medium other that the optical disc 100 (for example, a hard disc, a memory card or the like), it is possible to receive the same effects as the optical disc reproducing apparatus 1 receives by adopting the same structure as the optical disc reproducing apparatus 1 (specifically, the structure where the muting process is performed by the effect emulation processor 22 at intervals of several times per second).

The present invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The present invention can be applied to the information reproducing apparatus and method reproducing the video information or the sound information recorded in the recording medium, especially to the DJ equipment, VJ equipment or the like.

1-12. (canceled)

13. An information reproducing apparatus comprising:
a reading device for reading contents data;
an operating device constructed to rotate depending on an operation of a user;
a detecting device for detecting rotating operation performed on the operating device as operating signal;
a reproducing device for reproducing the contents data, while determining reproduction speed and reproduction direction of the contents data on the basis of the operating signal which shows a rotating operation of the user performed on the operating device; and
an adjusting device for adjusting reproducing intensity of a plurality of data parts distributed in the contents data periodically or discretely while the operating device is operated by the user during the reproduction of the contents data.

14. The information reproducing apparatus according to claim 13, further comprising: a configuring device for configuring whether or not to adjust the reproducing intensity; and wherein
the adjusting device the reproducing intensity, if the configuring device configures to adjust the reproducing intensity.

15. The information reproducing apparatus according to claim 13, wherein the adjusting device adjusts the reproducing intensity to “0”.

16. The information reproducing apparatus according to claim 13, further comprising: an adjusting amount changing device for changing an adjusting amount of the reproducing intensity.

17. The information reproducing apparatus according to claim 16, wherein the adjusting amount changing device changes the adjusting amount in response to at least one of an operation speed and an operation amount which relate to the rotating operation of the operating device.

18. The information reproducing apparatus according to claim 16, wherein the adjusting amount changing device changes the adjusting amount in response to an operation of the operating device other than rotating operation.

19. The information reproducing apparatus according to claim 13, further comprising: an interval changing device for changing intervals between the plurality of the data parts.

20. The information reproducing apparatus according to claim 19, wherein the interval changing device changes intervals between the plurality of the data parts in response to at least one of an operation speed and an operation amount which relate to the rotating operation of the operating device.

21. The information reproducing apparatus according to claim 19, wherein the interval changing device changes the intervals between the plurality of the data parts in response to an operation of the operating device other than rotating operation.

22. An information reproducing method of an information reproducing apparatus comprising: an operating device constructed to rotate depending on an operation of a user,
said information reproducing method comprising:
a reading process of reading contents data;
a reproducing process for reproducing the contents data, while determining reproduction speed and reproduction direction of the contents data on the basis of the operating signal which shows a rotating operation of the user performed on the operating device; and
an adjusting process for adjusting reproducing intensity of a plurality of data parts distributed in the contents data periodically or discretely while the operating device is operated by the user during the reproduction of the contents data.

23. A computer program product in a computer-readable medium of instructions for tangibly embodying a program of instructions executable by a computer provided in an information reproducing apparatus comprising a reading device for reading contents data; an operating device constructed to rotate depending on an operation of a user; a reproducing device for reproducing the contents data, while determining reproduction speed and reproduction direction of the contents data on the basis of the operating signal which shows a rotating operation of the user performed on the operating device; and an adjusting device for adjusting reproducing intensity of a plurality of data parts distributed in the contents data periodically or discretely while the operating device is operated by the user during the reproduction of the contents data,
said computer program making the computer function at least as one portion of the reading device, the reproducing device and the adjusting device.
